(19) United States
(12) Patent Application Publication
(10) Pub. No.: US 2011/0055553 A1
(43) Pub. Date: Mar. 3, 2011

(54) Method for controlling user access in sensor networks

(76) Inventors: Sung-Young Lee, Seongnam-si (KR); Young-Koo Lee, Suwon-si (KR); Xuan Hung Le, Namyangju-si (KR)

(21) Appl. No.: 12/547,689

(22) Filed: Aug. 26, 2009

(51) Int. Cl. H04L 29/06; G06F 21/00

(52) U.S. Cl. 713/155; 713/182

(57) ABSTRACT

A method for implement an energy-efficient user access control to wireless sensor networks is disclosed. A user creates a secret key and sending it to a sensor. The sensor builds a first MAC value by the secret key and sends it to the Key Distribution Center which builds a second MAC value and sending it to the sensor. The sensor decrypts the second MAC value to get a random number, and builds a third MAC value by the random number. The third MAC value is used by the user to authenticate the sensor.

### BACKGROUND OF THE INVENTION

1. Field of the Invention

This invention relates generally to security, and more specifically, relates to controlling user access in sensor networks.

2. Description of the Related Art

Due to privacy reason or data clearance, access restriction to sensor networks may be enforced for users with different access rights. For example, in a sensor network spread over a large geographic area, the maintainer of the network offers services to a large number of mobile users. In the network used for precision agriculture, farmers subscribe to services and remotely query sensors on their fields using a mobile device like PDA. In this case, only authorized users should be answered by the network.

The symmetric key based scheme suffers a number of problems including low scalability, large memory requirement, difficulty in new sensor deployment, and complicated key pre-distribution. The recent progress in public key cryptography using 160-bit Elliptic Curve Cryptography (ECC) shows that an ECC point multiplication takes less than one second on 8-bit CPU Atmel ATmega128 8 MHz (N. Gura, et al. Comparing Elliptic Curve Cryptography and RSA on 8-bit CPUs. In CHES2004, volume 3156 of LNCS, 2004). This proves that public-key cryptography is feasible for sensor security related applications.

### SUMMARY OF THE INVENTION

Thus, the present invention is based on ECC to design and further develop a method of above-mentioned kind in such a way that it is scalable, requires less memory, easy to deploy new nodes, and requires no complicated key pre-distribution.

According to the invention, the proposed method for access control is characterized in that the user authenticates to the sensor and vice versa via the KDC (Key Distribution Center) using ECC, whereby the sensor only computes symmetric cryptography which is quite feasible for sensor devices.

The user starts an access request by sending his certificate signed by an ECC private key to the sensor. Upon receiving the message, the sensor builds a first MAC (Message Authentication code) value by its ECC private key and sends it to the KDC. At KDC, it verifies if the user's certificate is legible or not. If yes, the user is authentic. The KDC then builds a second MAC value and sends it to the sensor. The sensor verifies it. If it is correct, then the user is authentic to the sensor. Otherwise, the sensor rejects the user. After that, the sensor decrypts the message from KDC to get the random number. It builds a third MAC value of this random number and sends it to the user. The user verifies it. If it is correct, then the sensor is authentic.

According to the invention, the mutual authentication is established based on the trust relationship between the user, the sensor and the KDC. The sensor trusts the KDC, so if the user is authentic to the KDC, it is authentic to the sensor as well. Likewise, the user trusts the KDC, so if the sensor is authentic to the KDC, it is authentic to the user.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating communication between the user, the authentication sensor node and the KDC via intermediate nodes of a sensor network according to an embodiment of the present invention.

FIG. 2 is a flowchart illustrating the method for controlling user access in sensor networks according to an embodiment of the present invention.

FIG. 3 illustrates a detailed scheme of the method for controlling user access in sensor networks according to an embodiment of the present invention.

### DETAILED DESCRIPTION OF THE PREFERRED EMBODIMENT

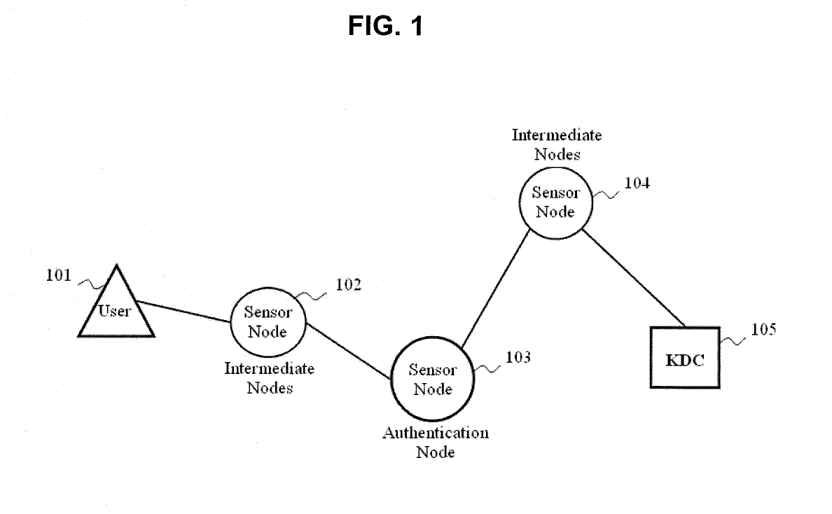

FIG. 1 illustrates communication between a user 101, an authentication sensor node 103 and a key distribution center (KDC) 105 via intermediate nodes 102, 104 of a sensor network according to an embodiment of the present invention.

Here, the term ‘user’ refers to either human or a device that he is using for access control. The KDC is responsible for generating all security primitives, issuing and revoking user's access privileges and the KDC is fully trusted. The intermediate nodes store a pair of ECC private and public key. The sending node and the receiving node know the ECC public key of each other.

Initially, the Key Distribution Center (KDC) 105 selects a particular elliptic curve over a finite field GF(p) (where p is a prime), and publishes a base point P with a large order q (q is also a prime). KDC 105 picks a random number k_{KDC}εGF(p) as the system private key, and publishes its corresponding public key Q_{KDC}=k_{KDC}×P. KDC 105 also generates private—public keys for each sensor node 102, 103, 104. To issue a private—public key pair for a sensor S with identifier ID_{S}, KDC 105 picks up a random number kₛεGF(p) and computes Qₛ=k_{S}×P. k_{S} is the private key assigned to sensor S while Q_{S} is the public key. Each sensor also has a public key Q_{KDC} of KDC 105 preloaded.

Notations are explained as follows: ID_{A} is identifier of entity A; k_{A} and Q_{A} is a pair of ECC private and public keys of entity A, respectively; sign_{A} (m) is message m is signed by entity A; (m)K is symmetric encryption of message m with key K; h(m) is hashing value of message m; ∥ is concatenation; x is ECC point multiplication.

After deployment, each sensor node computes a shared secret key with KDC 105 for later authentication and access control process. The present invention is based on Elliptic Curve Diffie-Hellman (ECDH) to establish a key agreement between each sensor node 102, 103, 104 and KDC 105. ECDH is a key agreement protocol allowing two parties to establish a shared secret key that can be used for private key algorithms. It has been shown that ECDH with 160-bit key size can achieve the same security level with 1024-bits RSA Diffie-Hellman secret sharing protocol.

To establish a shared secret key with KDC, a sensor node, say S, computes R_{S}=(x_{S}, y_{S})=k_{S}×Q_{KDC}. KDC also computes R_{KDC}=(x_{KDC}, y_{KDC})=k_{KDC}×Q_{S}. Since k_{S}×Q_{KDC}=k_{S}×k_{KDC}×P=k_{KDC}×Q_{S}, therefore R_{S}=R_{KDC} and hence x_{S}=x_{KDC}. As a result, xₛ is used as a shared secret key between node S and KDC. This key agreement is done only once for the whole network lifetime. As a consequence, it does not consume much energy overall. It can be performed before or right after network deployment.

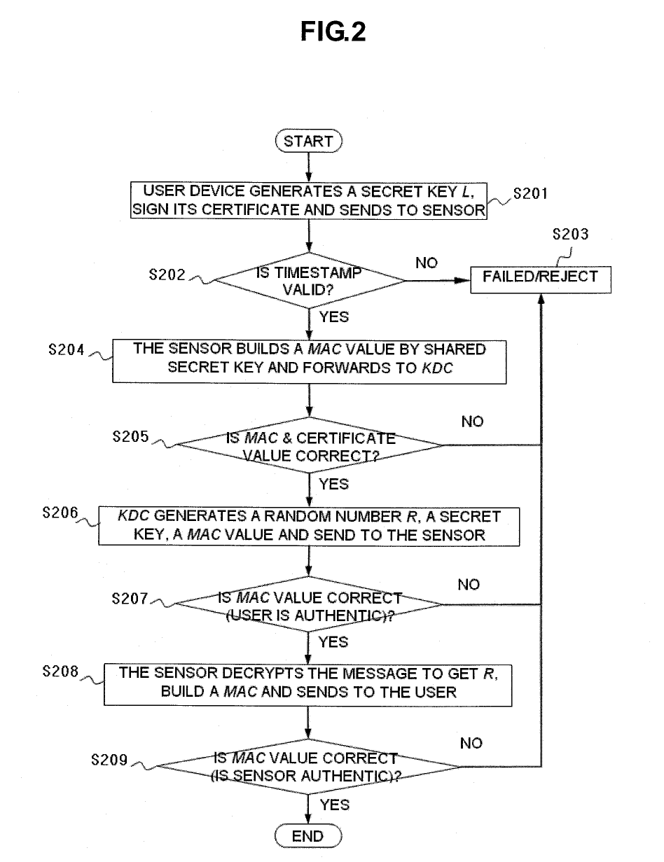

As shown by FIG. 2, in the first step S201/301, a user 101 sends an access control message to a sensor 103 which stores data that the user accesses.

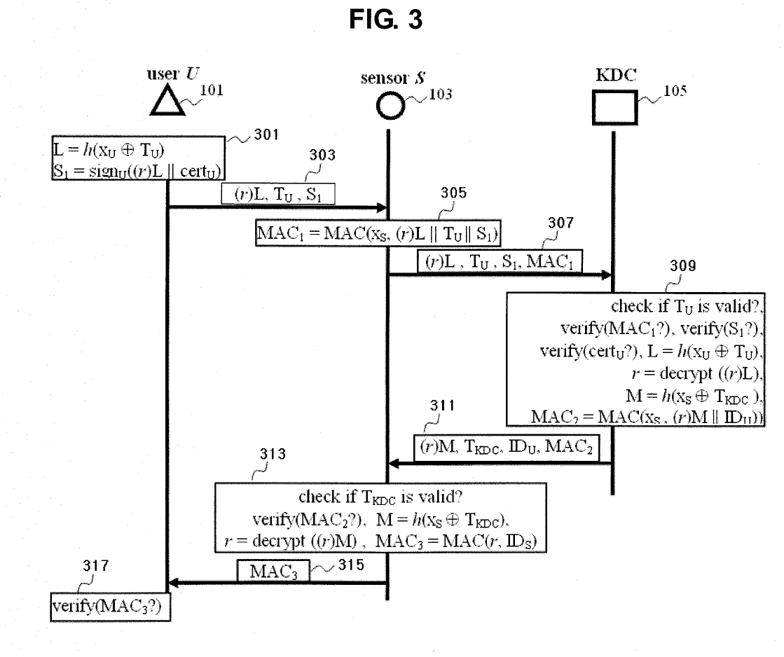

The user 101 selects a random number rεGF(p) which will be used as a session key with the sensor 103, as shown by FIG. 3, creates a secret key L=h(x_{U}⊕T_{U}) (where T_{U} is the current timestamp generated by the user), and encrypts r with key L. The user 101 then signs this encrypted value along with its certificate. The user 101 sends (r)L, T_{U}, S₁ to the sensor 103 (step 303).

Next, in step S202, upon receiving the message from the user 101, the sensor 103 first checks if the time T_{U} is valid.

If it is not valid, control jumps to step S203 where the sensor 103 rejects the user 101.

If yes, then control jumps to step S204/305 where the sensor 103 builds a MAC₁ by the shared secret key x_{S} (MAC₁=MAC(x_{S}, (r)L∥T_{U}∥S₁)) and then forwards the message along with MAC₁ value to KDC 105 (step 307), where MAC is a Message Authentication Code, preferably Cipher Block Chaining Message Authentication Code (CBC-MAC) is used.

Next, in step S205, upon receiving the message from the sensor 103, KDC 105 verifies MAC₁ value.

If it is not valid, control jumps to step S203 where KDC 105 rejects the user 101.

If the verification is successful, the sensor 103 is authentic to KDC 105 and control jumps to step S206/309. KDC 105 verifies S₁ which was signed by the user 101. If the signature is valid, then the user 101 is also authentic. The cert_{U} is also verified to check the validity of the access list ac_{U}. KDC 105 now constructs a secret key L=h(x_{U}⊕T_{U}), and decrypts (r)L to get r. It then generates a secret key M=h(x_{S}⊕T_{KDC}) (where T_{KDC} is the timestamp created by KDC 105), encrypts r, and builds a MAC₂ (MAC₂=MAC(x_{S}, (r)M∥ID_{U})). Afterward, KDC 105 sends them 311 to the sensor 103.

Next, in step S207, upon receiving the message from KDC 105, the sensor 103 verifies MAC₂ value.

If it is not valid, control jumps to step S203 where the sensor 103 rejects the user 101.

If the verification is successful, the user 101 is authentic to the sensor 103 and control jumps to step S208/313. The sensor 103 constructs the secret key M=h(x_{S}⊕T_{KDC}) and decrypts (r)M to get r. Using said secret key M, the sensor 103 builds a MAC₃ (MAC₃=MAC(r, ID_{S})) value and sends it to the user 101 (step 315).

Next, in step S209/317, upon receiving the MAC₃ value from the sensor 103, the user 101 verifies it by the same key r.

If it is not valid, control jumps to step S203 where the user 101 rejects the sensor 103.

If the verification is successful, then the sensor 103 is authentic to the user 101.

1-6. (canceled)

7. A method for controlling user access in sensor networks, comprising the steps of:
creating a secret key by a user and sending the secret key to a sensor;
building a first Message Authentication Code value by said sensor using said secret key and sending the first Message Authentication Code value to the Key Distribution Center;
building a second Message Authentication Code value by said Key Distribution Center and sending the second Message Authentication Code value to the sensor; and
decrypting the second Message Authentication Code value by said sensor to get a random number, building a third Message Authentication Code value using the random number and sending the third Message Authentication Code value to the user.

8. The method according to claim 7, wherein the step of creating a secret key by the user includes:
selecting a random number, encrypting the random number with the secret key to create an encrypted value, and signing the encrypted value along with a certificate of the user; and
wherein the step of sending the secret key to the sensor includes:
sending a message to the sensor with the encrypted value and a signed value.

9. The method according to claim 8, wherein sending the message to the sensor includes sending the message with a timestamp; and
wherein the step of building the first Message Authentication Code value by said sensor includes:
verifying if the timestamp is valid, and if said timestamp is not valid, then said sensor rejects said user, and if said timestamp is valid, then said sensor builds a first of Message Authentication Code value using said secret key.

10. The method according to claim 8, wherein the step of building the second Message Authentication Code value by said Key Distribution Center includes:
verifying if the certificate of the user is legible or not,
and if the certificate of the user is legible, then said Key Distribution Center builds a second Message Authentication Code value and sends the second of Message Authentication Code value to the sensor, and if the certificate of the user is not legible said Key Distribution Center rejects the user.

11. The method according to claim 7, wherein the step of decrypting the second Message Authentication Code value from the Key Distribution Center by said sensor includes:
verifying if the second Message Authentication Code value is correct or not,
and if the second Message Authentication Code value is not correct, then said sensor rejects said user and if the second Message Authentication Code value is correct, the sensor decrypts the second Message Authentication Code value from the Key Distribution Center.

12. The method according to claim 7, including, after sending the third Message Authentication Code value to the user:
verifying, by the user, if the third Message Authentication Code value is correct or not,
and if the third Message Authentication Code value is correct, then the sensor is deemed to authentic to the user and if the third Message Authentication Code value is not correct, the user rejects the sensor.
